(19) United States
(12) Patent Application Publication
(10) Pub. No.: US 2021/0119484 A1
(43) Pub. Date: Apr. 22, 2021

(54) WIRELESS POWER TRANSMISSION THROUGH A WINDOW

(71) Applicant: Ludlum Measurements, Inc., Sweetwater, TX (US)

(72) Inventors: John William Birks, Longmont, CO (US); Craig Joseph Williford, Golden, CO (US); Christine Ann Ennis, Longmont, CO (US)

(21) Appl. No.: 17/073,115

(22) Filed: Oct. 16, 2020

Related U.S. Application Data
(60) Provisional application No. 62/924,547, filed on Oct. 22, 2019.

(51) Int. Cl. H02J 50/00; H02J 50/05; H02J 50/10; B60L 1/14

(52) U.S. Cl. CPC H02J 50/005; B60L 1/14; H02J 50/10; H02J 50/05

(57) ABSTRACT

A system and method for wirelessly transmitting power through a window comprising transmitting and receiving coils or electrodes, which are embedded in or otherwise mounted with respect to flexible polymer suction cups. The transmitting and receiving coils or electrodes are arranged opposite one another on the interior and exterior of the window, respectively, via attachment of the suction cups thereon. Power provided to the transmitting coil or electrode, for example from an auxiliary power adapter of a vehicle, may be transmitted through the window by inductive coupling or capacitive coupling. The power provided to the receiving coil or electrode can then be used to power external devices such as taxi roof signs, lighted advertising signs, spotlights and other auxiliary off-road lights, trailer tail lights, emergency and warning lights, speakers, cameras, battery chargers, and packages of scientific instruments for measuring air pollutants and various environmental factors such as weather parameters.

### BACKGROUND

There are many applications where it is necessary to power a removable accessory or other device attached to the outside of a vehicle such as an automobile or truck. Some common examples include lighted taxi roof signs, lighted advertising signs, spotlights and other auxiliary off-road lights, trailer tail lights, emergency and warning lights, still and video cameras, and speakers. A recent and growing interest is in the mounting of scientific instrument packages on vehicles for hyperlocal mapping of air pollutants (see Apte et al., 2017), meteorological parameters such as temperature, pressure and humidity, and other environmental parameters such as visible, infrared and ultraviolet radiation, and audible noise, for example. Currently, such devices are generally powered either by the device's internal battery, by wiring the device to the vehicle's battery, or by feeding the device's power cable to the interior of the vehicle and plugging into the vehicle's accessory power, such as a 12-V cigarette lighter adapter or 5-V USB adapter. The use of internal batteries alone is undesirable in most cases because they must be recharged or replaced relatively frequently. Wiring directly to the vehicle battery can be difficult and requires expertise. Passing a power cable through a window in order to connect the device to the vehicle's internal auxiliary power, as is often done, is undesirable since the window must be partially open, which may be a nuisance to passengers in terms of pressure effects when driving, noise and other external conditions like weather or temperature, and the wiring itself may be a nuisance to passengers, especially when entering and exiting the vehicle where the window is part of a door. Special modifications to the vehicle structure (e.g., vehicle frame apertures) for running wiring are also generally undesirable, since such structural modifications can be relatively expensive, affect performance during crash events, and require remedial work to restore the vehicle structure if the modifications are no longer desired, for example if a device is no longer to be used with that vehicle.

The foregoing examples of the related art and limitations therewith are intended to be illustrative and not exclusive. Other limitations of the related art will become apparent to those of skill in the art upon a reading of the specification and a study of the drawings.

### SUMMARY

Proceeding from this background, an innovative solution is disclosed to the problem of powering external accessories attached to vehicles, which is to couple the power directly through the glass or polymer of one of the vehicle's windows. In this way, accessory power may be used to provide power to devices attached to the exterior of the vehicle, such as those described above, without the need to feed a cable between the interior and exterior of a vehicle. This solution may be expanded to non-vehicle applications as well, such as building windows.

Wireless power transmission has been known at least since the work of Nikola Tesla beginning in about 1891 (see Singh et al., 2012), and it is already established that transmitting and receiving coils can be used to transmit alternating current (ac) power through dielectric materials such as glass. Wireless power transmission is now commonly used to charge batteries of electric toothbrushes, razors, mobile phones, cameras and other devices. Inductive charging is well known and can even be used to charge the batteries of electric vehicles. Although charging of a battery without an electrical connection is the most common application, inductive power transmission can be used to directly power a device such as an electric light, speaker, etc. Inductive coupling can be used in the Hz to MHz frequency range. Electric toothbrushes typically make use of 60 Hz line frequency, but higher energy transfer efficiency is achieved if the frequency is stepped up to the MHz range.

Using an inductive coupling system and method, the accessory direct current (dc) power can be converted to ac using a power inverter, and transmission through window glass achieved by using two coils—a transmitter coil placed against the interior of the window and a receiver coil placed on the exterior of the window. If desired, the received ac power can be converted back to dc power using a rectifier, or preferably a switched mode power supply (SMPS). For maximal power transmission efficiency, the transmitting and receiving coils should be centered on one another and the diameter of the transmitting and receiving coils should be much greater than the distance between the coils.

An alternative embodiment involves the use of capacitive coupling (see Kline, 2010) using opposing electrodes (e.g., flat conductive plates) for energy transfer, with the transmitting plate or set of transmitting plates held near or at the surface of the inside of the window by a polymer suction cup, and the receiving plate or set of receiving plates held near or at the surface of the exterior of the window by another polymer suction cup. Capacitive coupling makes use of an oscillating electric field to transfer energy, while inductive coupling makes use of an oscillating magnetic field. Advantages of the approach of capacitive coupling over inductive coupling include: the complexity and cost of manufacturing of a set of capacitive plates is typically less than that of inductive coils; alignment between the transmitting and receiving plates is generally less critical than for coils; and electromagnetic interference (EMI) is typically reduced for capacitive coupling as compared to inductive coupling. In the past, a disadvantage was the much higher voltages typically required for capacitive coupling as compared to inductive coupling, although recent advances have allowed efficient coupling at voltages of a few tens of volts (see Kline, 2010).

Either capacitive coupling or inductive coupling may be used for a system and method according to the present disclosure.

In either case, at least two polymer suction cups are provided for easy mounting and removal from the window. At least one cup has a transmitter coil or electrode, and at least one cup has a corresponding receiver coil or electrode. Use of rubber or other polymer suction cups significantly simplifies and speeds up the process of setting up and powering an electrically-powered accessory device on the exterior of a vehicle compared to other arrangements, while also avoiding issues associated with running power cables through an open window. For example, a taxi driver who uses her/his car for both business and personal use could easily apply power to a detachable lighted taxi sign without feeding the power line through a window or other vehicle orifice. In another application, for example, a rideshare (e.g., Uber or Lyft) or delivery vehicle driver can easily provide power to a roof-mounted air measurement package for making automated measurements of air pollutants, meteorological and/or environmental parameters throughout the course of his or her travels.

It should be appreciated that the present disclosure applies to any application where it is desirable to transmit power through a sheet of dielectric material. For example, it may be desirable to power an electrical device outside a building (e.g., a house) where there is no convenient electrical outlet. In that case, power could be transmitted through a building window. The use of transmitting and receiving coils or electrodes within flexible polymer suction cups makes it easy and convenient to attach, center and remove the transmitting and receiving coils or electrodes to the interior and exterior surfaces of a window, or any other flat or moderately curved sheet of dielectric material such as glass or various polymers. Although the descriptions herein are generally provided in the context of vehicle window applications, the present disclosure is not limited to vehicle window applications.

The following embodiments and aspects thereof are described and illustrated in conjunction with systems, tools and methods which are meant to be exemplary and illustrative, not limiting in scope. In various embodiments, one or more of the above described problems have been reduced or eliminated, while other embodiments are directed to other improvements.

The present disclosure relates to a system and method for transmitting power through a vehicle window for the purpose of powering an accessory device attached to the exterior of the vehicle. Examples of accessory devices to be powered include but are not limited to lighted taxi roof signs, lighted advertising signs, spotlights and other auxiliary off-road lights, trailer tail lights, emergency and warning lights, speakers, cameras, and packages of one or more scientific instruments for measuring air pollutants and various environmental factors such as weather parameters. Further, the accessory device may be a battery charger or power supply unit, which in turn is used to power another device or devices.

The setup of power transmission through the car window comprises transmitting and receiving coils embedded or otherwise mounted in flexible polymer suction cups. The transmitting coil is mounted on the interior of the window by use of the suction cup, and the receiving coil is mounted on the exterior of the window using another suction cup directly opposite and centered on the transmitting coil. The dc voltage of the vehicle's accessory power, typically 12-V or 5-V, is converted to ac prior to connection to the transmitting coil. Alternatively, the transmitting coil may be connected directly to an ac power source. The ac voltage induced in the receiving coil may optionally be converted to dc, depending on the requirements of the device being powered.

Accordingly, one aspect is a device and method for transmitting power through the window of a vehicle such as a car, truck, bus, tram, train, aircraft or boat by means of inductive coupling.

In embodiments with inductive coupling, a further aspect is the optional use of resonant inductive coupling to increase energy transfer efficiency using transmitting and receiving coils tuned to the same resonant frequency.

Another aspect is the use of suction cups to provide the transmitting and receiving coils for easy attachment and removal from the vehicle window. The coils can be mounted in hollowed out sections of the cups (e.g., the suction cavity), or preferably are embedded in the same or a different polymer or other dielectric material near the surface of the suction cup, preferably proximate the surface of the window.

Another aspect is the alternative use of capacitive coupling, rather than inductive coupling, for energy transfer through the vehicle window. Again, a further aspect is the use of polymer suction cups to align the transmitting and receiving electrodes and provide an easy way to attach and detach the electrodes. The transmitting and receiving electrodes can either be mounted in a hollowed out region of the suction cup (e.g., the suction cavity), or embedded in the same or a different polymer or other dielectric material, preferably proximate the surface of the window.

Another aspect is the conversion of dc accessory power of the vehicle to ac using an inverter or other electrical device.

Another aspect is the optional conversion of the ac power picked up by the receiving coil, or electrode, to dc for powering of one or more accessory devices attached to the vehicle, such as lighted taxi roof signs, lighted advertising signs, spotlights and other auxiliary off-road lights, trailer tail lights, emergency and warning lights, still and video cameras, speakers, and scientific measurement packages, for example those designed to measure air pollutants and/or environmental parameters such as meteorological parameters, noise, radiation of various wavelengths, etc.

In addition to the exemplary aspects and embodiments described above, further aspects and embodiments will become apparent by reference to the accompanying drawings forming a part of this specification wherein like reference characters designate corresponding elements or structures in the several views.

### BRIEF DESCRIPTION OF THE DRAWINGS

The following descriptions are provided on the basis of example embodiments with reference to the appended figures, wherein:

FIG. 1 shows a schematic system diagram, from a partial side view along the plane of a window, illustrating the transmission of electrical power through the window vehicle via inductive coupling;

FIG. 2 shows a schematic system diagram, from a partial side view along the plane of a window, illustrating the transmission of electrical power through the window via capacitive coupling;

FIG. 3 shows another schematic system diagram, from a partial side view along the plane of a window, illustrating the transmission of electrical power through the window via capacitive coupling;

FIG. 4 shows a schematic diagram from a sectional side view of a flexible polymer suction cup containing a fully embedded electrical coil for the purpose of either transmitting or receiving power;

FIG. 5 shows a schematic diagram from a sectional side view of a flexible polymer suction cup containing a partially embedded electrical coil for the purpose of either transmitting or receiving power;

FIG. 6 shows a schematic diagram from a sectional side view of a flexible polymer suction cup containing a fully embedded capacitor plate for the purpose of either transmitting or receiving power;

FIG. 7 shows a schematic diagram from a sectional side view of a flexible polymer suction cup containing a partially embedded capacitor plate for the purpose of either transmitting or receiving power;

FIG. 8 shows a schematic diagram from a sectional side view of a flexible polymer suction cup containing a pair of fully embedded capacitor plates for the purpose of either transmitting or receiving power; and

FIG. 9 shows a schematic diagram from a sectional side view of a flexible polymer suction cup containing a pair of partially embedded capacitor plates for the purpose of either transmitting or receiving power.

Before further explaining the depicted embodiments, it is to be understood that the invention is not limited in its application to the details of the particular arrangements shown, since the invention is capable of other embodiments. It is intended that the embodiments and figures disclosed herein are to be considered illustrative rather than limiting. Also, the terminology used herein is for the purposes of description and not limitation.

### DETAILED DESCRIPTION

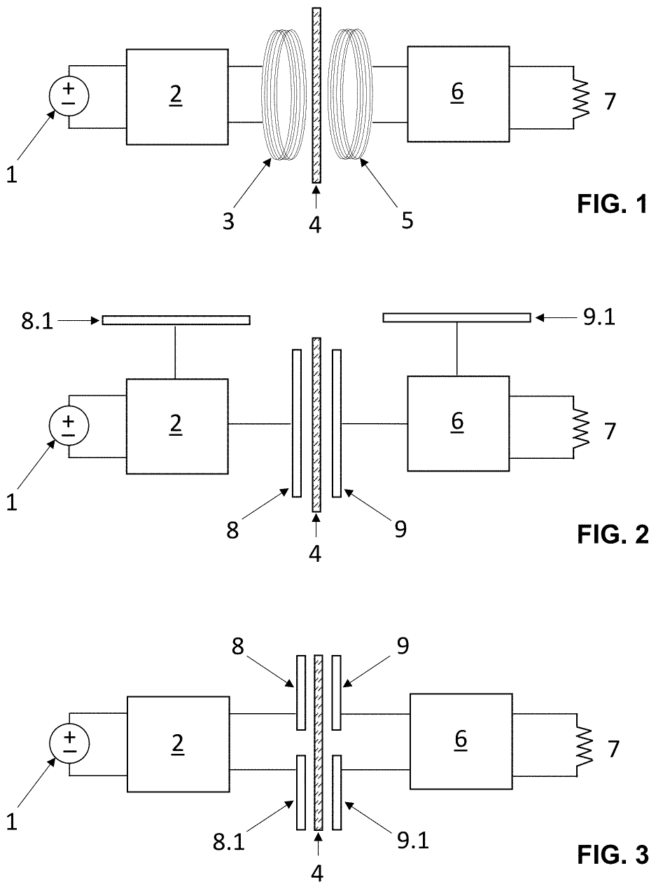

An embodiment with inductive electrical power transmission through a dielectric material such as glass or other dielectric material is depicted in FIG. 1. A dc power source 1 is converted to ac power by a power inverter 2, and the output ac current passes through a transmitter coil 3. Alternatively, the inverter 2 may be omitted where the power source 1 is an ac power source. The transmitter coil 3 is positioned on one side of the window 4. A receiver coil 5 is positioned on the other side of the window 4. Provided that window 4 is a dielectric material such as glass, and that the coils 3 and 5 are positionally aligned across the window 4 and sufficiently close together, typically less than a few centimeters, the oscillating magnetic field produced by the ac current in the transmitter coil 3 induces an oscillating current in the receiver coil 5. Preferably, the distance between the coils 3 and 5 is less than a few millimeters. The current in the receiver coil 5 can then be utilized by the accessory device, either as a source of ac power, or by conversion to a dc voltage via power converter 6, which can be a rectifier circuit composed of diodes but more commonly is a switched-mode power supply (SMPS) circuit. Load resistor 7 represents the exterior accessory device being powered. Preferably, the transmitter coil 3 and the receiver coil 5 have the same resonant frequency.

An embodiment with wireless electrical power transmission via capacitive coupling through a dielectric material such as glass or other dielectric material is depicted in FIG. 2. Again, dc power from the power source 1 is converted to ac power by the inverter 2. Alternatively, the inverter 2 may be omitted where the power source 1 is an ac power source. The output ac current is fed to an electrode which comprises a flat capacitor plate 8 in this system. This transmitter electrode is positioned on one side of the window 4. Another electrode comprising a flat capacitor plate 9 is positioned on the other side of the window 4. Provided that window 4 is a dielectric material such as glass, and that the plates 8 and 9 are positionally aligned across the window 4 and sufficiently close together, typically less than a few centimeters, the oscillating electric field produced by the ac current in the transmitter plate 8 induces an oscillating current in the receiver plate 9. Preferably, the distance between the plates 8 and 9 is less than a few millimeters. The current in the receiver plate 9 can then be utilized by the accessory device, either as a source of ac power, or by conversion to a dc voltage via power converter 6, which can be a rectifier circuit composed of diodes but more commonly is a switched-mode power supply (SMPS) circuit. Load resistor 7 represents the exterior accessory device being powered. Passive electrodes 8.1 and 9.1 on the transmitter side and on the receiver side, respectively, provide current return path.

Another embodiment with wireless electrical power transmission via capacitive coupling through a dielectric material such as glass or other dielectric material is depicted in FIG. 3. Again, dc power from the power source 1 is converted to ac power by the inverter 2. Alternatively, the inverter 2 may be omitted where the power source 1 is an ac power source. The output ac current is fed to an electrode which comprises two flat capacitor plates 8, 8.1 in this system. The power source 1 and inverter 2 are connected between the transmitter plates 8, 8.1. This transmitter electrode is positioned on one side of the window 4. Another electrode comprising two flat capacitor plates 9, 9.1 is positioned on the other side of window 4. The converter 6 and load resistor 7 are connected between the receiver plates 9, 9.1. Provided that window 4 is a dielectric material such as glass, and that the plates 8, 9 and the plates 8.1, 9.1 are positionally aligned across the window 4 and sufficiently close together, typically less than a few centimeters, the oscillating electric field produced by the ac current in the transmitter plates 8, 8.1 induces an oscillating current in the receiver plates 9, 9.1. Preferably, the distance between the plates 8, 8.1 and 9, 9.1 is less than a few millimeters. The matched pairs of the plates 8, 9 and the plates 9, 9.1, respectively, are driven in opposite phase, 180° out of phase. The current in the receiver plates 9, 9.1 can then be utilized by the accessory device, either as a source of ac power, or by conversion to a dc voltage via power converter 6, which can be a rectifier circuit composed of diodes but more commonly is a switched-mode power supply (SMPS) circuit. Load resistor 7 represents the exterior accessory device being powered.

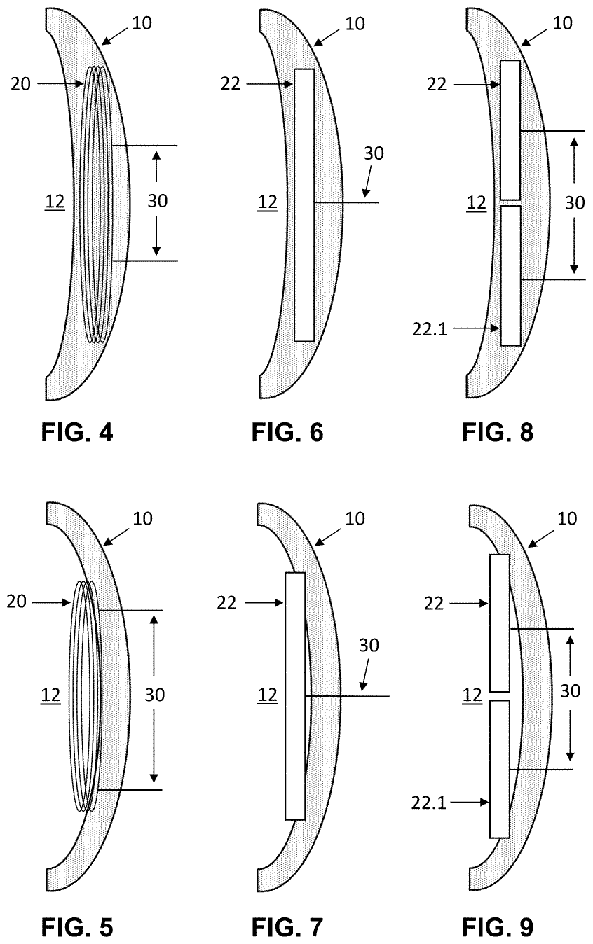

Referring to FIGS. 4 and 5, a transmitting or receiving coil 20 is embedded in a suction cup 10. The coil 20 corresponds to either one of coils 3, 5 for inductive coupling (see FIG. 1). The suction cup 10 is a flexible polymer suction cup here. The suction cup 10 has a hollow suction cavity 12 for suction mounting of the cup 10 to the window surface. The coil 20 is connected to electrical leads 30 which protrude from the polymer. In this example, the electrical leads 30 protrude from the suction cup 10 on a side thereof opposite the cavity 12. The electrical leads 30 connect the coil 20 to either the transmitter side or the receiver side of the system. The coil 20 may be completely embedded in the polymer material of the cup 10 (see FIG. 4) or partially embedded in the polymer material of the cup 10 (see FIG. 5), or may be mounted in the cavity 12 or another open cavity formed within the polymer by adhesive or fastening structures (not shown). The transmitting and receiving coils may be identical, or one coil could be of a different diameter and/or have a different number of windings. Efficiency of power transfer is optimized if the two coils are matched in terms of resonant frequency. The suction cups may be of any practical size to house the coil and ensure secure attachment to the window, but for most applications fall in the range of ˜1 to ˜5 inches (˜2.5 to ˜12.5 cm). A number of coils and associated electronics for dc-to-ac and ac-to-dc conversion designed for inductive power transmission are commercially available, and one skilled in the art would be able to design coils for specific applications with different power requirements.

Referring to FIGS. 6 and 7, a transmitting or receiving plate 22 is embedded in the suction cup 10. The flat capacitor plate 22 corresponds to single plate 8 or 9 for capacitive coupling (see FIG. 2). Again, the suction cup 10 is a flexible polymer suction cup here, with the hollow suction cavity 12 for suction mounting of the cup 10 to the window surface. The plate 22 is connected to a single electrical lead 30 which protrudes from the polymer. In this example, the electrical lead 30 protrudes from the suction cup 10 on a side thereof opposite the cavity 12. The electrical lead 30 connects the plate 22 to either the transmitter side or the receiver side of the system. The plate 22 may be completely embedded in the polymer material of the cup 10 (see FIG. 6) or partially embedded in the polymer material of the cup 10 (see FIG. 7), or may be mounted in the cavity 12 or another open cavity formed within the polymer by adhesive or fastening structures (not shown). One skilled in the art would be able to select suitable plates for specific applications with different power requirements, as well as incorporate associated electronics for conversion and compensation as needed.

Referring to FIGS. 8 and 9, a pair of transmitting or receiving plates 22, 22.1 are embedded in the suction cup 10. The flat capacitor plates 22, 22.1 corresponds to either one of paired plates 8, 8.1 or 9, 9.1 for capacitive coupling (see FIG. 3). Again, the suction cup 10 is a flexible polymer suction cup here, with the hollow suction cavity 12 for suction mounting of the cup 10 to the window surface. Each plate 22, 22.1 is connected to one of the electrical leads 30, which protrude from the polymer. In this example, the electrical leads 30 protrude from the suction cup 10 on a side thereof opposite the cavity 12. The electrical leads 30 connect the plates 22, 22.1 to either the transmitter side or the receiver side of the system. The plates 22, 22.1 may be completely embedded in the polymer material of the cup 10 (see FIG. 8) or partially embedded in the polymer material of the cup 10 (see FIG. 9), or may be mounted in the cavity 12 or another open cavity formed within the polymer by adhesive or fastening structures (not shown). The suction cup 10 may include an orientation indicator or marking to help ensure that the plates 22, 22.1 are properly aligned with the plates of the other cup during installation. One skilled in the art would be able to select suitable plates for specific applications with different power requirements, as well as incorporate associated electronics for conversion and compensation as needed.

In FIGS. 4 through 9, the concave surface of the suction cup 10 defining the hollow suction cavity 12 behind the plane of these views is not shown, though it is understood that the suction cup would extend around the periphery of its vacuum cavity in contacting the mounting surface.

With capacitive coupling embodiments, the electrodes may comprise other configurations with multiple plates, including those with different matrixes and arrangements on one side than the other side. The wireless transmission system and suction cup design is not necessarily limited by the specific configurations depicted and described herein.

Accordingly, in an example method for transmitting power through a window for powering an accessory device (e.g., a device attached to an exterior of a vehicle), the method comprises: mounting a first suction cup to an interior surface of the window and mounting a second suction cup to an exterior surface of the window, such that the first suction cup on the interior surface and the second suction cup on the exterior surface are positionally aligned with one another on either side of the window, wherein the first suction cup comprises a transmitter coil or electrode, and the second suction cup comprises a receiver coil or electrode; feeding ac power to the transmitter coil or electrode of the first suction cup; wirelessly transmitting power from the transmitter coil or electrode of the first suction cup to the transmitter coil or electrode of the second suction cup; and feeding power wirelessly received by the transmitter coil or electrode of the second suction cup to the accessory device. The power fed to the transmitter coil or electrode of the first suction cup may be ac power from an ac power source, for example utility mains or an ac power source of a vehicle or another device. Alternatively, the method may further comprise converting dc power from a dc power source, via an inverter, into ac power fed to the transmitter coil or electrode of the first suction cup for wireless power transmission to the second suction cup. The accessory device may utilize ac power wirelessly received by the receiver coil or electrode of the second suction cup. Alternatively, the accessory device may utilize dc power, wherein the method further comprises converting ac power wirelessly received by the receiver coil or electrode of the second suction cup, via a converter, into dc power which is fed to the accessory device. Where the transmitter coil or electrode of the first suction cup and the receiver coil or electrode of the second suction cup are coils, power is wirelessly transmitted from the transmitter coil of the first suction cup to the receiver coil of the second suction cup via inductive coupling. Where the transmitter coil or electrode of the first suction cup and the receiver coil or electrode of the second suction cup are electrodes, for example one or more flat capacitor plates, power is wirelessly transmitted from the transmitter electrode of the first suction cup to the receiver electrode of the second suction cup via capacitive coupling.

While a number of aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and sub-combinations possible of the group are intended to be individually included in the disclosure.

In general, the terms and phrases used herein have their art-recognized meaning, which can be found by reference to standard texts, journal references and contexts known to those skilled in the art. The above definitions are provided to clarify their specific use in the context of the invention.

### CITED LITERATURE

Apte, J. S., Messier, K. P., Gani, S., Brauer, M., Kirchstetter, T. W., Lunden, M. M., Marshall, J. D., Portier, C. J., Vermeulen, R. C. H. and Hamburg, S. P., “High-resolution Air Pollution Mapping with Google Street View Cars: Exploiting Big Data”, Environmental Science & Technology, Vol. 51, No. 12, pp. 6999-7008 (2017).
Kline, M., “Capacitive Power Transfer”, Technical Report No. UCB/EECS-2010-155, Electrical and Engineering and Computer Sciences, University of California at Berkeley (2010).
Singh, S. K., Hasarmani, T. S. and Molmukhe, R. M., “Wireless Transmission of Electrical Power Overview of Recent Research and Development”, International Journal of Computer and Electrical Engineering, Vol. 4, No. 2, pp. 207-211 (2011).

1. A system for transmitting power through a window for powering an accessory device, comprising:
a first suction cup with a hollow suction cavity for mounting the first suction cup to an interior surface of the window, the first suction cup comprising a transmitter coil or electrode connected to one or more electrical leads;
a second suction cup with a hollow suction cavity for mounting the second suction cup to an exterior surface of the window, the second suction cup comprising a receiver coil or electrode connected to one or more electrical leads.

2. The system of claim 1, further comprising an inverter electrically connected to the transmitter coil or electrode of the first suction cup, the inverter configured to convert dc power from a dc power source into ac power fed to the transmitter coil or electrode of the first suction cup.

3. The system of claim 1, further comprising a converter electrically connected to the receiver coil or electrode of the second suction cup, the converter configured to convert ac power from the transmitter coil or electrode of the second suction cup into dc power fed to the accessory device.

4. The system of claim 3, wherein the converter is a switched-mode power supply circuit or a rectifier circuit.

5. The system of claim 1, wherein the first suction cup and the second suction cup are flexible polymer suction cups.

6. The system of claim 1, wherein the transmitter coil or electrode of the first suction cup is fully embedded within material of the first suction cup.

7. The system of claim 1, wherein the receiver coil or electrode of the second suction cup is fully embedded within material of the second suction cup.

8. The system of claim 1, wherein the transmitter coil or electrode of the first suction cup is positioned within the hollow suction cavity of the first suction cup and partially embedded in material of the first suction cup.

9. The system of claim 1, wherein the receiver coil or electrode of the second suction cup is positioned within the hollow suction cavity of the second suction cup and partially embedded in material of the second suction cup.

10. The system of claim 1, wherein the one or more electrical leads to the transmitter coil or electrode protrude from the first suction cup on a side opposite the hollow suction cavity of the first suction cup.

11. The system of claim 1, wherein the one or more electrical leads to the receiver coil or electrode protrude from the second suction cup on a side opposite the hollow suction cavity of the second suction cup.

13. The system of claim 1, wherein the transmitter coil or electrode of the first suction cup and the receiver coil or electrode of the second suction cup are coils, and the coils have the same resonant frequency.

14. The system of claim 1, wherein the transmitter coil or electrode of the first suction cup and the receiver coil or electrode of the second suction cup are electrodes, and each electrode comprises one or more flat capacitor plates, with each flat capacitor plate being connected to one of the electrical leads.

15-22. (canceled)
